(19) United States
(12) Patent Application Publication
(10) Pub. No.: US 2006/0011307 A1
(43) Pub. Date: Jan. 19, 2006

(54) Labeling machine

(76) Inventor: Andrea Sarzi Madidini, Goito (IT)

Correspondence Address: MODIANO & ASSOCIATI, Via Meravigli, 16, Milan, 20123, IT

(21) Appl. No.: 11/177,426

(22) Filed: Jul. 11, 2005

(30) Foreign Application Priority Data
Jul. 13, 2004 (IT) MN2004A000017

(51) Int. Cl. B65C 9/00

(52) U.S. Cl. 156/567

(57) ABSTRACT

A labeling machine comprising a rotating carousel for supporting a plurality of pans, each designed to support a bottle to be labeled and provided with means adapted for turning them about their own axis, the means comprising a kinematic chain which draws motion from the shaft of the carousel and comprises at least one element which is interchangeable in order to allow variations of the rotation rate of the pans for an equal rotation rate of the carousel.

The invention relates to a labeling machine.

### BACKGROUND OF THE INVENTION

Labeling machines are known which comprise a rotating carousel for supporting a plurality of pans, each designed to support a bottle to be labeled and provided with means adapted to rotate them about their own axis.

The rotation rate of the carousel is linked to the productivity of the machine: if such rate is increased, the number of bottles processed in the time unit increases also.

The rotation rate of the pans that support the bottles to be labeled is linked to the diameter of such bottles: as said diameter changes, it is necessary to vary the rotation rate of the pans.

It is therefore evident that there must be no rigid link between such two rotation rates, and, in the background art, the means suitable for turning the pans comprise a motor with controllable rotation rate which operates independently of the motor drive of the rotating carousel.

### SUMMARY OF THE INVENTION

However, this solution entails a very high installation cost, and therefore the aim of the present invention is to provide a labeling machine in which the means adapted for turning the pans for supporting the bottles to be labeled are constructively very simple and highly functional, in that they allow to vary the rotation rate of the pans independently of variations of the rotation rate of the carousel.

This aim is achieved by a labeling machine according to the invention comprising a rotating carousel for supporting a plurality of pans, each designed to support a bottle to be labeled and provided with means adapted for turning them about their own axis, characterized in that said means comprise a kinematic chain which draws motion from the shaft of the carousel and comprises at least one element which is interchangeable in order to allow variations of the rotation rate of said pans for an equal rotation rate of said carousel.

### BRIEF DESCRIPTION OF THE DRAWINGS

Further characteristics and advantages of the present invention will become better apparent from the description of a preferred but not exclusive embodiment of the labeling machine according to the invention, illustrated by way of non-limiting example in the accompanying drawings, wherein:

FIG. 1 is a schematic front view of a labeling machine of the invention, with some parts shown in cross-section;

FIGS. 2 and 4 are views of a detail of the machine equipped with pulleys that are different from the one shown in FIG. 1;

FIGS. 3 and 5 are schematic plan views of the machine equipped respectively with the pulleys shown in FIGS. 2 and 4.

### DESCRIPTION OF THE PREFERRED EMBODIMENTS

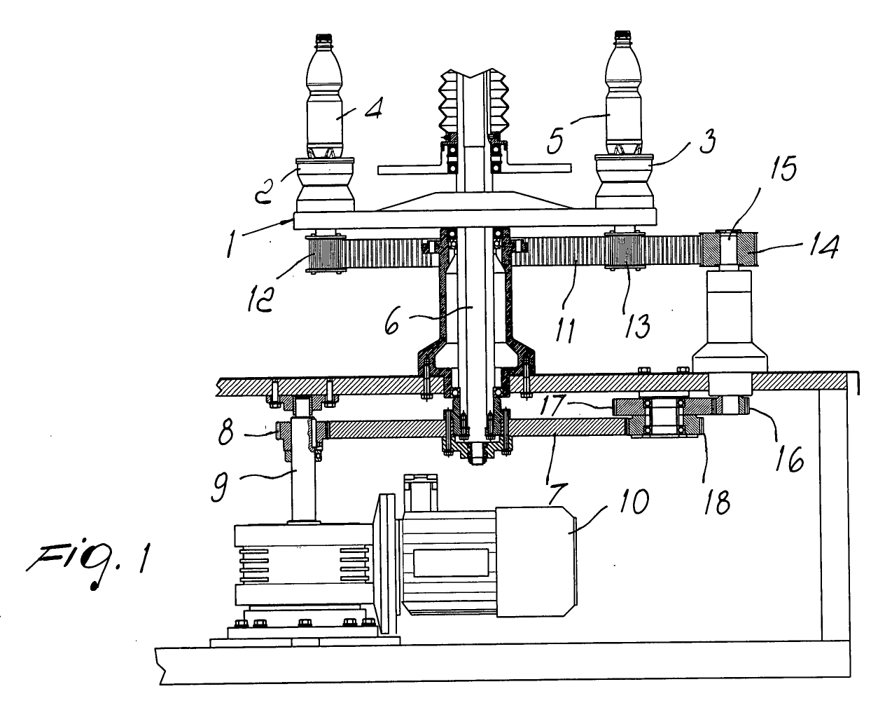

With reference to FIG. 1, the reference numeral 1 generally designates the rotating carousel of the machine, which supports a plurality of pans 2 and 3, each designed to support a bottle 4 and 5 to be labeled; the shaft 6 of the carousel 1 is turned by means of a gear 7 rigidly coupled thereto, and meshes with a pinion 8 which is keyed on an output shaft 9 of a gearmotor 10.

All this occurs in a known manner.

An important feature of the invention consists in that the pans 2 and 3 are provided with means adapted for turning them about their own axis, which comprise a kinematic chain, which in turn comprises a belt 11, which works in combination with individual pulleys which are rigidly coupled to said pans, such as 12 and 13 for the pans 2 and 3 respectively, and the belt 11 is driven by means of a pulley 14, which is keyed to a shaft 15 which receives motion, by virtue of a toothed pinion 16, a gear 17 and a pinion 18, from the toothed gear 7, which is keyed to the driving shaft 6 of the carousel.

The pulley 14 is interchangeable, and it is therefore possible, by replacing such pulley with one having an appropriate different diameter, to vary the rotation rate of the pans, giving such rate the optimum value in relation to the diameter of the bottles to be labeled, for an equal rotation rate of the carousel.

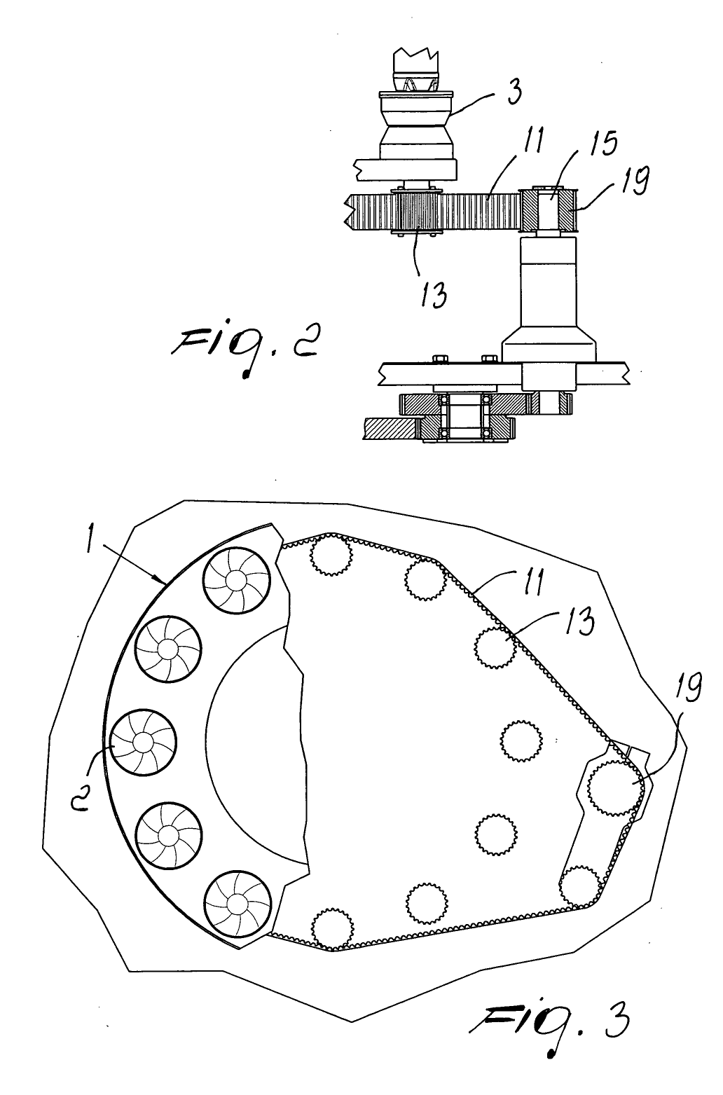

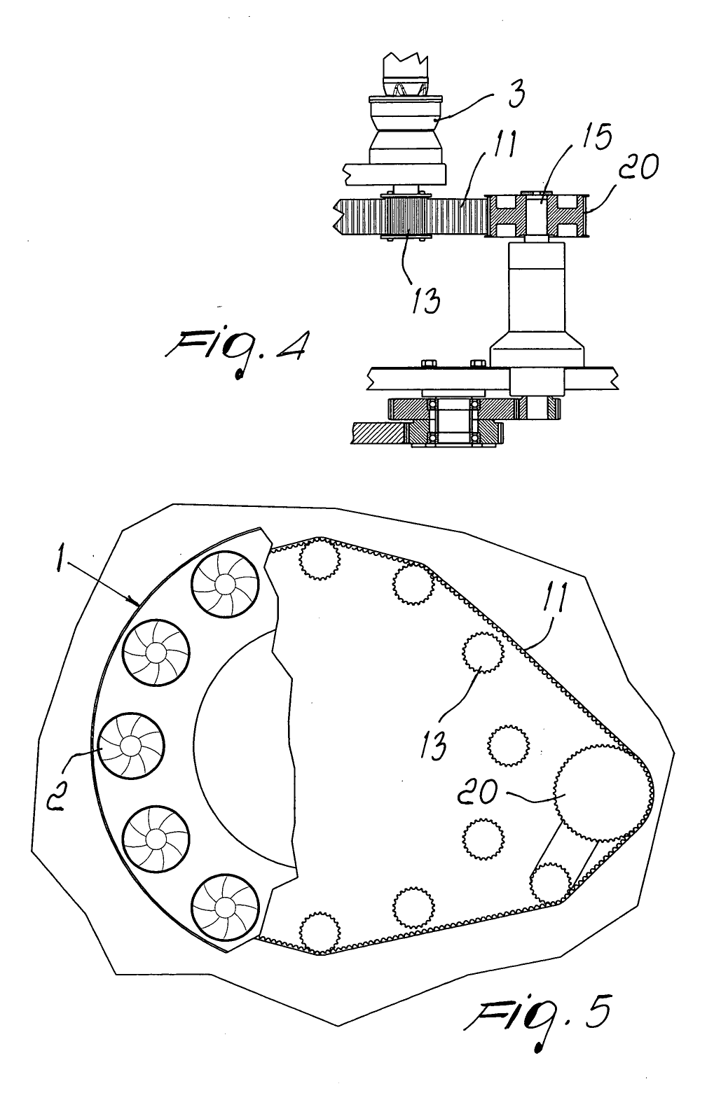

Accordingly, FIGS. 2 and 3 illustrate the installation on the machine of a pulley 19, which has a smaller diameter than the pulley 14 which has been replaced, and FIGS. 4 and 5 instead illustrate the machine equipped with a pulley 20, which has a larger diameter than said pulley 14: accordingly, the belt 11, and the bottle supporting pans with it, is respectively slower and faster than in the presence of the pulley 14, and this occurs for an equal rotation rate of the shaft 6 of the carousel 1 and therefore of the shaft 15 on which the pulleys are keyed.

The described invention is susceptible of numerous modifications and variations, all of which are within the scope of the appended claims; all the details may further be replaced with other technically equivalent elements.

The disclosures in Italian Patent Application No. MN2004A000017 from which this application claims priority are incorporated herein by reference.

What is claimed is:

1. A labeling machine comprising a rotating carousel for supporting a plurality of pans, each designed to support a bottle to be labeled and provided with means adapted for turning them about their own axis, wherein said means comprise a kinematic chain which draws motion from the shaft of the carousel and comprises at least one element which is interchangeable in order to allow variations of the rotation rate of said pans for an equal rotation rate of said carousel.

2. The labeling machine according to claim 1, wherein the kinematic chain adapted to turn the pans about their own axis comprises a belt which works in combination with individual pulleys rigidly coupled to each one of said pans, said belt being driven by an interchangeable pulley, which draws its motion from the shaft of the carousel.
